(19) United States
(12) Patent Application Publication
(10) Pub. No.: US 2014/0115648 A1
(43) Pub. Date: Apr. 24, 2014

(54) METHOD AND APPARATUS FOR BROADCAST TV CONTROL

(71) Applicants: Garry M Paxinos, Pompano Beach, FL (US); Anastasios Kyriakides, Hollywood, FL (US); Kenneth Alvin Hosfeld, Coral Spring, FL (US); Anastasios Nicholas Kyriakides, II, Plantation, FL (US)

(72) Inventors: Garry M Paxinos, Pompano Beach, FL (US); Anastasios Kyriakides, Hollywood, FL (US); Kenneth Alvin Hosfeld, Coral Spring, FL (US); Anastasios Nicholas Kyriakides, II, Plantation, FL (US)

(21) Appl. No.: 14/057,448

(22) Filed: Oct. 18, 2013

Related U.S. Application Data
(60) Provisional application No. 61/715,536, filed on Oct. 18, 2012.

(51) Int. Cl. H04N 21/236; H04N 21/238

(52) U.S. Cl. CPC H04N 21/236; H04N 21/238
USPC 725/116

(57) ABSTRACT

A method, apparatus and system to provide the ability for a user to have improved OTA reception of TV signals. The system employs an antenna, a media receiver/player and/or display, and a datacenter. The antenna is placed with line of sight to broadcast towers and is provided with clean wiring from the antenna through the building to a the TV. A high performance TV tuner and a demodulator are included in the TV or STB. A datacenter located in relevant Television Market Area is incorporated to receive, process and make available correction packets over a network. Under typical circumstances, an OTV television signal as broadcast contains degradation in the form of a number of error packets in the broadcast stream by the time it is received by an antenna. The system employed detects and marks of error packets and replaces them with good packets delivered over a network.

### CROSS REFERENCE TO RELATED APPLICATIONS

This application claims the benefit of and incorporates by reference co-pending U.S. provisional patent application Ser. No. 61/715,536 filed Oct. 18, 2012.

### BACKGROUND OF THE INVENTION

1. Field of the Invention

This invention relates generally to broadcast television signals and, more particularly, to a method and apparatus for enhancing over the air television signals by replacing error packets in the broadcast stream.

2. Description of the Prior Art

Broadcast television, or over the air (“OTA”) television (or “TV”), as an audio/video content distribution means to a dispersed audience is well known. Since the 1930s, OTA television has been offered commercially in the United States (“U.S.”), usually through the transmission of audio/video signals through the air as radio waves from a transmitter, to be picked up by an antenna and sent to a receiver.

Broadcast television transmissions in the U.S. have long been regulated in a manner which separates areas into specified Television Market Areas (“TMA”)(also referred to as “Designated Market Areas”) to be covered by a specific group of broadcast TV stations. While virtually all locations in the U.S. fall into one TMA, it is observed that sometimes TMAs cover a larger area than the OTA signals of the broadcast TV stations that serve it can reach. Consequently, the TMA regulations lead to a problem wherein, due to degradation of OTA signals from the broadcast television stations in a TMA, outlying areas of a TMA cannot receive quality OTA signals from one or more of the broadcast TV stations in the TMA. Such areas are often only served by cable or satellite television signals.

Thus, there remains a need for a method and apparatus which supplements OTA signals received from broadcast TV stations so as to improve the quality of the resultant audio/video content to be viewed. It would be helpful if such a broadcast TV control method and apparatus was structured to provide for erroneous packets in the OTA signal to be detected and marked. It would be additionally desirable for such a broadcast TV control method and apparatus to be structured to replace marked erroneous packets with good packets delivered over a network.

The Applicant's invention described herein provides for a method and apparatus which identifies degradation in OTV television signals and corrects for the same. The primary components in Applicants' broadcast TV control method and apparatus include a television antenna, a modified television receiver, and a data center. When in operation, the broadcast TV control method and apparatus provides a complete and accurate OTA television signal for display to an end user. As a result, many of the limitations imposed by the prior art are either greatly simplified or removed.

### SUMMARY OF THE INVENTION

A method, apparatus and system to provide the ability for a user to have improved OTA reception of TV signals. The system employs an antenna and receiver, a TV or a set top box (with a connected TV)(“STB”), and a datacenter. The antenna is placed reasonably within line of sight to broadcast towers and wiring from the antenna through the building to a the TV. A TV tuner and a demodulator (“demod”) are included in the TV, STB, or other information appliance or consumer device. Under typical circumstances, an OTV television signal as broadcast contains degradation in the form of a number of error packets in the broadcast stream by the time it is received by an antenna. The system employed herein leverages the detection and marking of error packets in a modern demod and replaces them with good packets delivered over a network.

A datacenter located in the relevant TMA is incorporated to receive, process and make available correction packets over a network. The TV or STB are configured, through hardware and/or software, to replace error packets with good packets from the network and integrate the corrected signal before display.

The system incorporates broadcast TV stations (or “broadcasters”) in each TMA and a network distribution system, including the Internet, content delivery networks (“CDN”) and broadband providers.

In one embodiment, the MPEG Transport Stream is a protocol, as it is used in modern TV systems worldwide. Flags, defined as bits within a packet, such as those currently known in the market may be used to mark packets containing errors. For example, the text of the flag may read: “Transport Error Indicator (“TEI”); Set by demodulator if it can't correct errors in the stream, to tell the demultiplexer that the packet has an uncorrectable error.” Similarly, a continuity packet, which essentially maintains count of packets in a stream for sequential ordering, is provided so that if non-continuity is detected in a packet stream, the gap in packets can be filled in.

It is an object of this invention to provide a method and apparatus which supplements OTA signals received from broadcast TV stations so as to improve the quality of the resultant audio/video content to be viewed.

It is another object of this invention to provide a broadcast TV control method and apparatus structured to provide for erroneous packets in the OTA signal to be detected and marked.

It is yet another object of this invention to provide a broadcast TV control method and apparatus structured to replace marked erroneous packets with good packets which were delivered over a network.

These and other objects will be apparent to one of skill in the art.

### BRIEF DESCRIPTION OF THE DRAWINGS

FIG. 1 shows a block diagram of the operative elements of a broadcast TV control method and apparatus according to one embodiment of the present invention.

FIG. 2 shows a block diagram of the operative internal components and external connections of a set to box configured for broadcast TV control in accordance with the present invention.

FIG. 3 shows a process flow for data handling in accordance with the present invention.

FIG. 4 shows a process for signal correction in accordance with the present invention.

### DETAILED DESCRIPTION OF THE INVENTION

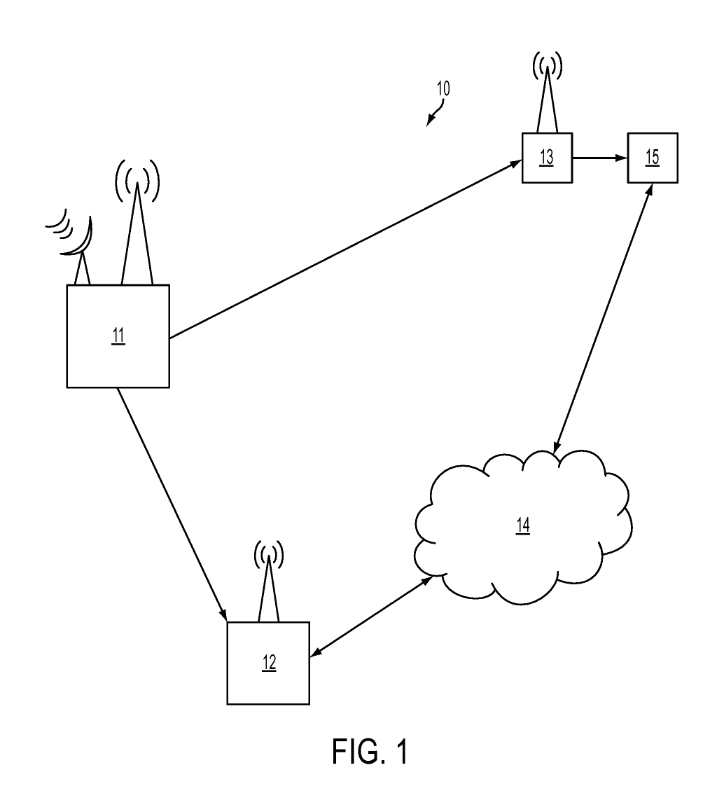

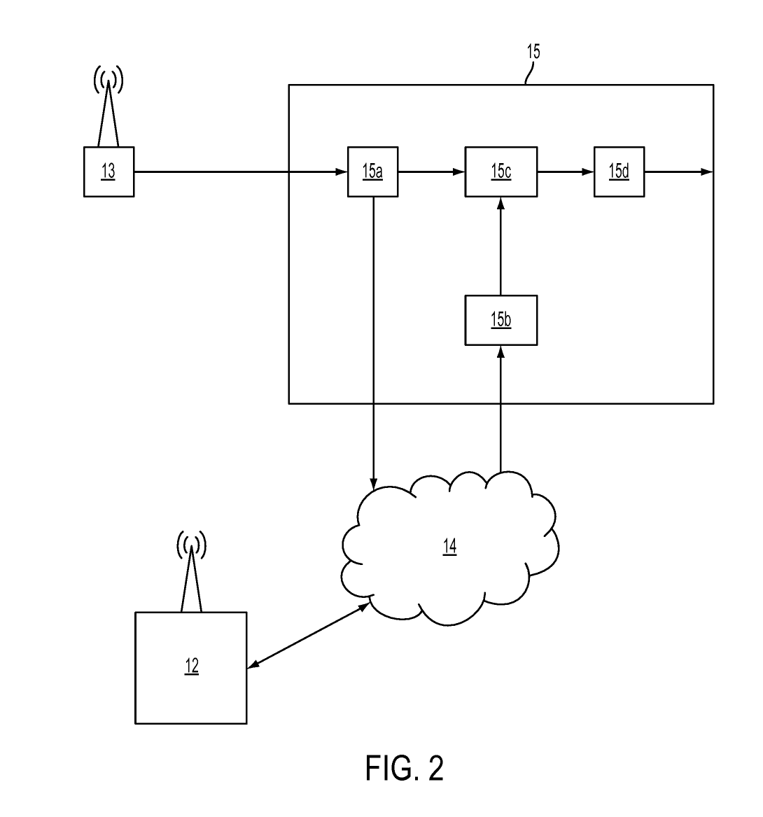

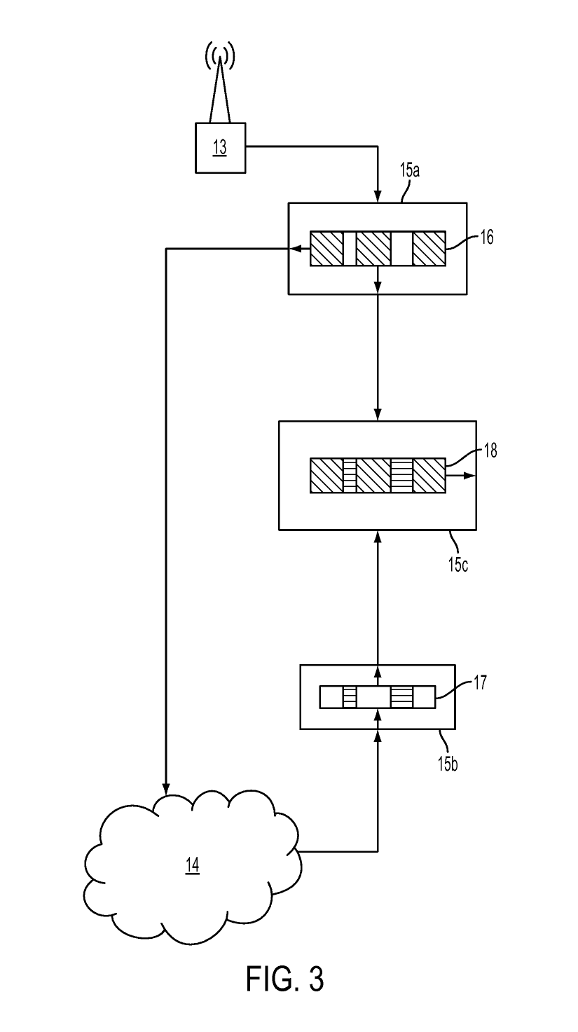

Referring now to the drawings and in particular FIGS. 1, 2, and 3, the primary elements of a broadcast TV control system 10 include a broadcast TV stations 11, a datacenter 12, a computer network, an antenna 13, and a display apparatus. The broadcast TV station 11 represents one or more television signal broadcasters in a defined TMA or across a plurality of TMAs. The television signal broadcast by the broadcast TV station 11 is desirously received by the antenna 13 at the location of an end user of the system 10, or at a location which otherwise services the display apparatus of the such an end user. The antenna 13 is a conventional digital television antenna.

The datacenter 12 is located having a proximity and reasonable line of sight orientation so as to receive the television signal broadcast from the relevant broadcast TV station(s) 11 in its entirety, with essentially no errors. Once the signal is received, the datacenter 12 processes the signal, enabling it to make available correction packets for transmission over the computer network, defined as the Internet 14 in typical configurations. In one embodiment, the datacenter 12 includes a tuner and a demodulator which allows it to decode the incoming television signal and separate it into packets for transmission. The datacenter 12 may be configured to transmit specifically designated packets to a target destination upon receiving a request over the Internet 14 for particular correction from a display apparatus. In the alternative, the datacenter 12 may be configured to transmit all packets associated with the incoming signal, enabling a display apparatus to determine locally which packets to use. It is appreciated, though that an embodiment wherein the datacenter 12 transmits specifically designated packets to a destination allows for signal correction while typically having lower data transmission requirements.

The display apparatus is defined by a set top box 15 that adapted to connect to a display device, such as a television set, and to receive a television signal from an antenna 13, turning the a signal from the antenna 13 into content in a form that can then be displayed on the television set screen or other display device in accordance with the present invention. In other embodiments, the display apparatus can be a television which is adapted to receive a television signal from an antenna 13, turn the a signal from the antenna 13 into content in a form that can then be displayed in accordance with the present invention, and display the content. In yet another embodiment, the display apparatus is an alternate information appliance, defined as a machine or device that is usable for the purposes of computing, telecommunicating, reproducing, and presenting encoded information in myriad forms and applications, such as a video game console, media player/receiver (including steaming Internet players), or a computer, provided the alternate information appliance is adapted receive a television signal from an antenna 13, turn the a signal from the antenna 13 into content in a form that can then be displayed in accordance with the present invention, and/or display the content.

The set top box 15 is configured to improve and/or enhance OTA television signals received by the antenna 13 through its internal components and external connections. The set top box 15 includes a digital tuner/receiver, defined in one embodiment by a DTV receiver 15a, which is configured to receive a digital signal from the antenna 13, isolate a particular, desired channel, forward the signal to a demodulator to be converted to electronic data elements, defined as an OTA packet stream 16 in binary format, and check for and mark the packets in the OTA packet stream 16 which containing errors. If any packets in the OTA packet stream 16 are determined to have an uncorrectable error, the DTV receiver 15a requests from the datacenter 12, through the Internet 14, the transmission of a network packet stream 17 having correction packets to replace those in the OTA packet stream 16 having an uncorrectable error. In response, the datacenter 12 transmits the network packet stream 17, embodied as replacement good packets that lack errors, over the Internet 14 to a network receiver 15b in the set top box 15 from which the request for the network packet stream 17 originated. The in the set top box 15, the OTA packet stream 16 is sent from the DTV receiver 15a to an error correction multiplexer 15c and the network packet stream 17 is sent from the network receiver 15b to the error correction multiplexer 15c. A delay line, defined as a buffer in one embodiment, is provided to allow time for the packet request and the fulfillment of the packet request to be transmitted. The error correction multiplexer 15c combines the OTA packet stream 16 and the network packet stream 17 into a corrected packet stream 18. In one embodiment, the error correction multiplexer additionally takes the corrected packet stream 18 and extracts audio, video, and data from the binary stream to be usable by an audio/video decoder 15d.

Once the corrected packet stream 18 is produced and prepared for the audio/video decoder 15d, the audio, video and data from the corrected packet stream 18 is transmitted to the audio/video decoder 15d, where the digital bits are transformed into a format suitable for viewing on the television set or other display device. In an embodiment wherein the display apparatus is defined by a set top box or other information appliance that is connected to a separate display device, the transformed audio, video and data from the corrected packet stream 18 is then sent to the display device for viewing. In embodiments wherein the display apparatus is defined by a display device additionally configured to receive and correct television signals in accordance with the present invention, the transformed audio, video and data from the corrected packet stream 18 is simply displayed on the screen of the device and through the audio interface of the device.

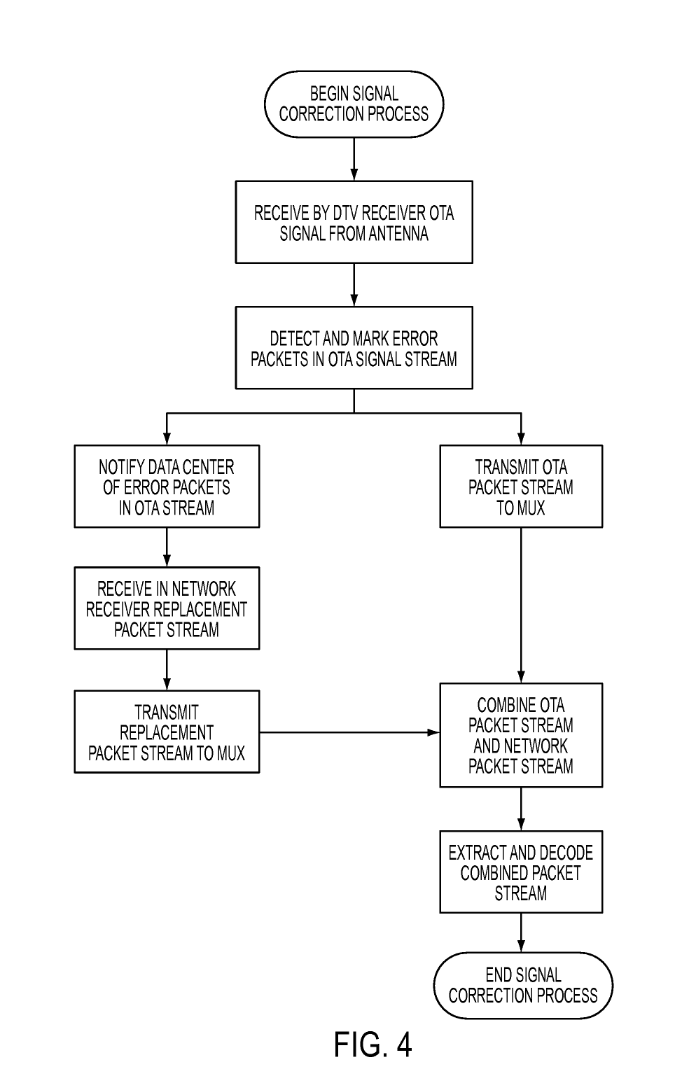

Referring now to FIG. 4, the signal correction process begins with a DTV receiver in a display apparatus, defined in one embodiment as a set top box, receiving an OTA television signal from an antenna. It is contemplated that the OTA television signal would originate from a broadcast TV station in the TMA where the antenna is disposed, but it is understood that in accordance with the present process, the OTA television signal could originate anywhere. Once the OTA television signal is received, it is processed by the DTV receiver into a OTA packet stream, with any packets in the stream which contain uncorrectable errors being marked with a flag and any continuity gaps in the stream being marked with a flag. Such a flag may be a conventional TEI flag, enabling the packet to be recognized as unusable. The flagged packets are then removed from the OTA packet stream and the OTA packet stream is transmitted to an error correcting multiplexer in the set top box.

At the same time, a request for correction packets which correspond to flagged and/or removed/missing packets in the OTA packet stream is transmitted from the set top box to a datacenter. The datacenter is located and oriented so that its antennae are able to receive a OTA television signals from the relevant broadcast TV station(s) which produce a substantially error free packet stream. As such the datacenter is enabled to process OTA television signals it receives directly and avail a network packet stream containing correction packets to a set top box identifying flagged and removed packets. Upon receiving a request for correction packets for flagged and/or removed/missing packets from a particular set top box, the datacenter transmits a network packet stream which has the requisite error free packets to replace the flagged packets in the OTA packet stream of the particular set top box. This transmission is received by a network receiver in the set top box and the network receiver then forwards the network packet stream to the error correcting multiplexer in the set top box. It is appreciated that in one embodiment, an implementation for the networking protocol could be HLS-HTTP Live Streaming.

Having both the OTA packet stream and the network packet stream, the error correcting multiplexer then combines the streams into a combined packet stream. At that point, the combined packet stream defines the OTA packet stream, with all of the packets which contained uncorrectable errors replaced with error free packets from the network packet stream. The combined packet stream is then extracted and decoded into a format suitable for viewing on a display device, ending the signal correction process.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for enhancing over the air television signals, comprising the steps of:
providing an information appliance configured to receive television signals from a television antenna and adapted to turn the television signal into content in a form that can be displayed by an output display, wherein said television antenna is configured to receive over the air television transmissions and transmit television signals relating to received television transmissions to said information appliance;
providing a datacenter configured to receive the same over the air television transmissions received by the television antenna and transmit datacenter electronic data elements relating to television transmissions received by the data center to said information appliance over a computer network, wherein said information appliance is additionally configured to receive datacenter electronic data elements from said datacenter over the computer network;
processing by said information appliance television signals received from said antenna into a processed television signal, wherein the step of processing includes converting the television signal into OTA electronic data elements, identifying OTA electronic data elements in the television signal which have uncorrectable errors and removing the identified OTA electronic data elements;
causing said datacenter to transmit to said information appliance datacenter electronic data elements which lack uncorrectable errors and are capable of replacing at least one removed OTA electronic data element in the processed television signal; and
merging by said information appliance the datacenter electronic data elements with the processed television signal such that at least one network electronic data element replaces at least one removed OTA electronic data element.

2. The method of claim 1, additionally comprising the step of providing an output display.

3. The method of claim 2, additionally comprising the step of transforming by said information appliance said processed television signal into a transformed television signal which has a format suitable for viewing on the output display.

4. The method of claim 3, additionally comprising the step of causing said transformed television signal to be displayed on said output display.

5. The method of claim 3, wherein the output display and the information appliance are disposed in discrete housings.

6. The method of claim 5, wherein a set top box defines the information appliance and a television defines the output display.

7. The method of claim 3, wherein the output display and the information appliance are disposed in the same housing.

8. The method of claim 1, wherein the OTA electronic data elements and the network electronic data elements are collectively embodied as an OTA packet stream in binary format and a network packet stream in binary format, respectively.

9. The method of claim 1, wherein the step of merging causes all removed OTA electronic data elements to be replaced with network electronic data elements.

10. A method for enhancing broadcast signals received by a user, comprising the steps of:
providing an information appliance configured to receive content signals from a antenna and adapted to turn the content signal into audio, video, or audio and video in a form that can be output by a user interface, wherein said antenna is configured to receive broadcast transmissions and transmit content signals relating to received broadcast transmissions to said information appliance;
providing a datacenter configured to receive the same broadcast transmissions received by the antenna and transmit datacenter electronic data elements relating to broadcast transmissions received by the data center to said information appliance over a computer network, wherein said information appliance is additionally configure to receive datacenter electronic data elements from said datacenter over the computer network;
processing by said information appliance content signals received from said antenna into a processed content signal, wherein the step of processing includes converting the content signal into broadcast electronic data elements, identifying broadcast electronic data elements in the content signal which have uncorrectable errors and removing the identified broadcast electronic data elements;
causing said datacenter to transmit to said information appliance datacenter electronic data elements which lack uncorrectable errors and are capable of replacing at least one removed broadcast electronic data element in the processed content signal; and
merging by said information appliance the datacenter electronic data elements with the processed content signal such that at least one network electronic data element replaces at least one removed broadcast electronic data element.

11. The method of claim 10, wherein said broadcast transmissions are defined by electromagnetic radio waves.

12. A system for enhancing over the air television signals, comprising:
an information appliance configured to receive television signals from a television antenna and adapted to turn the television signal into content in a form that can be displayed by an output display, wherein said television antenna is configured to receive over the air television transmissions and transmit television signals relating to received television transmissions to said information appliance;
a datacenter configured to receive the same over the air television transmissions received by the television antenna and transmit datacenter electronic data elements relating to television transmissions received by the data center to said information appliance over a computer network, wherein said information appliance is additionally configure to receive datacenter electronic data elements from said datacenter over the computer network;
wherein said information appliance processes television signals received from said antenna into a processed television signal, wherein the such processing includes converting the television signal into OTA electronic data elements, identifying OTA electronic data elements in the television signal which have uncorrectable errors and removing the identified OTA electronic data elements;
wherein said datacenter is caused to transmit to said information appliance datacenter electronic data elements which lack uncorrectable errors and are capable of replacing at least one removed OTA electronic data element in the processed television signal; and
wherein said information appliance merges the datacenter electronic data elements with the processed television signal such that at least one network electronic data element replaces at least one removed OTA electronic data element.

13. The system of claim 12, additionally comprising an output display.

14. The system of claim 13, wherein said information appliance additionally processes said processed television signal into a transformed television signal which has a format suitable for viewing on the output display.

15. The system of claim 14, wherein said transformed television signal is displayed on said output display.

16. The system of claim 14, wherein the output display and the information appliance are disposed in discrete housings.

17. The system of claim 16, wherein a set top box defines the information appliance and a television defines the output display.

18. The system of claim 14, wherein the output display and the information appliance are disposed in the same housing.

19. The system of claim 12, wherein the OTA electronic data elements and the network electronic data elements are collectively embodied as an OTA packet stream in binary format and a network packet stream in binary format, respectively.

20. The system of claim 12, wherein all removed OTA electronic data elements are replaced with network electronic data elements.
